(19) United States
(12) Patent Application Publication
(10) Pub. No.: US 2017/0242572 A1
(43) Pub. Date: Aug. 24, 2017

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Seiji INOUE, Kanagawa (JP)

(73) Assignee: FUJI XEROX CO., LTD., Tokyo (JP)

(21) Appl. No.: 15/233,687

(22) Filed: Aug. 10, 2016

(30) Foreign Application Priority Data
Feb. 18, 2016 (JP) 2016-028770

(51) Int. Cl. G06F 3/0484; G06F 9/445

(52) U.S. Cl. CPC G06F 3/04847; G06F 3/04842; G06F 8/65

(57) ABSTRACT

An information processing apparatus includes a setting value input unit, a first memory, and a second memory. The setting value input unit displays a setting item selection screen for selecting a setting item for which a setting value is to be input, displays, in response to selection of a setting item on the setting item selection screen, a setting value input screen for inputting a setting value of the setting item, and receives a setting value. The first memory stores an additional program for implementing a newly added additional function. The second memory stores a plug-in program which is configured to be able to dynamically cooperate with a system program that controls the entire information processing apparatus and which contains information for inputting a setting value necessary to implement the additional function.

### CROSS-REFERENCE TO RELATED APPLICATIONS

This application is based on and claims priority under 35 USC 119 from Japanese Patent Application No. 2016-028770 filed Feb. 18, 2016.

### BACKGROUND

### Technical Field

The present invention relates to an information processing apparatus and a non-transitory computer readable medium.

### SUMMARY

According to an aspect of the invention, there is provided an information processing apparatus including a setting value input unit, a first memory, and a second memory. The setting value input unit displays a setting item selection screen for selecting a setting item for which a setting value is to be input, displays, in response to selection of a setting item on the setting item selection screen, a setting value input screen for inputting a setting value of the setting item, and receives a setting value. The first memory stores an additional program for implementing a newly added additional function. The second memory stores a plug-in program which is configured to be able to dynamically cooperate with a system program that controls the entire information processing apparatus and which contains information for inputting a setting value necessary to implement the additional function. The setting value input unit forms the setting item selection screen and the setting value input screen by obtaining, from the plug-in program, name information about a setting item of the setting value necessary to implement the additional function on the setting item selection screen and information about the setting value to be input for the setting item.

### BRIEF DESCRIPTION OF THE DRAWINGS

Exemplary embodiments of the present invention will be described in detail based on the following figures, wherein:

FIG. 1 is a diagram illustrating the configuration of an image forming system including an image forming apparatus according to a first exemplary embodiment of the present invention;

FIG. 2 is a diagram for describing an example of screen transition in a case where an application program for adding a new function is not installed;

FIG. 3 is a diagram for describing an example of screen transition in a case where an application program for adding a new function is not installed;

FIG. 4 is a diagram for describing a case of adding, to common setting functions, a setting value input function for inputting a setting value of an accumulated-document print function that has been added, by using a method similar to that according to the related art;

FIG. 5 is a diagram for describing a state where an accumulated-document print application developer creates an accumulated-document print application program and an accumulated-document print setting plug-in program and installs them in the image forming apparatus;

FIG. 6 is a block diagram illustrating the hardware configuration of the image forming apparatus according to the first exemplary embodiment of the present invention;

FIG. 7 is a block diagram illustrating the functional configuration regarding a setting function of the image forming apparatus according to the first exemplary embodiment of the present invention;

FIG. 8 is a diagram illustrating an example of information about setting values of accumulated-document print setting transmitted from the accumulated-document print setting plug-in program to a system program;

FIG. 9 is a diagram illustrating an example of screen transition of a setting screen in the image forming apparatus according to the first exemplary embodiment of the present invention;

FIG. 10 is a diagram illustrating an example of screen transition of a setting screen in the image forming apparatus according to the first exemplary embodiment of the present invention;

FIG. 11 is a diagram illustrating an example of screen transition of a setting screen in the image forming apparatus according to the first exemplary embodiment of the present invention;

FIG. 12 is a diagram illustrating an example of storing setting values in a setting value memory;

FIG. 13 is a block diagram illustrating the functional configuration regarding a setting function of an image forming apparatus according a second exemplary embodiment of the present invention;

FIG. 14 is a diagram for describing a difference between the configuration according to the second exemplary embodiment and the configuration according to the first exemplary embodiment of the present invention;

FIG. 15 is a diagram illustrating an example of screen transition information transmitted from an email notification setting plug-in program to a system program;

FIG. 16 is a diagram illustrating an example of call information generated by a call information generator;

FIG. 17 is a diagram illustrating an example of screen transition of a setting screen in the image forming apparatus according to the second exemplary embodiment of the present invention; and

FIG. 18 is a diagram illustrating an example of screen transition of a setting screen in the image forming apparatus according to the second exemplary embodiment of the present invention.

### DETAILED DESCRIPTION

Hereinafter, exemplary embodiments of the present invention will be described in detail with reference to the attached drawings.

### First Exemplary Embodiment

First, an image forming apparatus 10 according to a first exemplary embodiment of the present invention will be described.

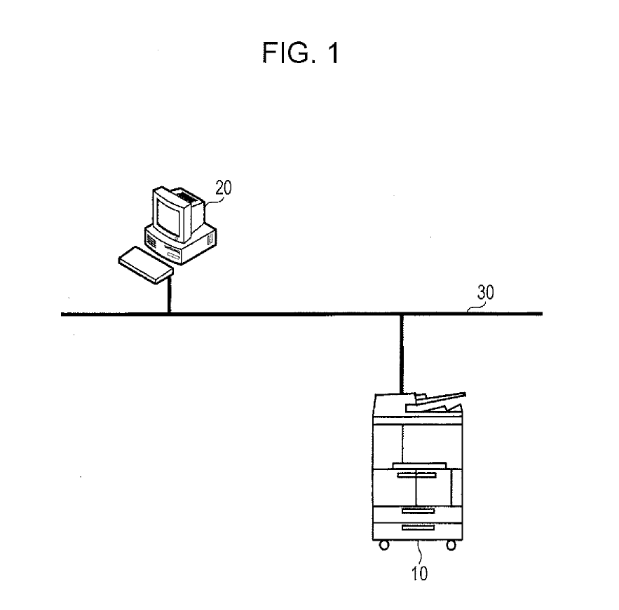

FIG. 1 is a diagram illustrating the configuration of an image forming system including the image forming apparatus 10 according to the first exemplary embodiment of the present invention.

The image forming system according to the exemplary embodiment includes, as illustrated in FIG. 1, the image forming apparatus 10 and a terminal apparatus 20 that are connected to each other via a network 30. The terminal apparatus 20 generates print data and transmits the generated print data to the image forming apparatus 10 via the network 30. The image forming apparatus 10 receives the print data transmitted by the terminal apparatus 20 and outputs an image corresponding to the print data onto paper. The image forming apparatus 10 is an apparatus that is so-called a multifunction peripheral having plural functions, such as a print function, a scan function, a copy function, and a facsimile function.

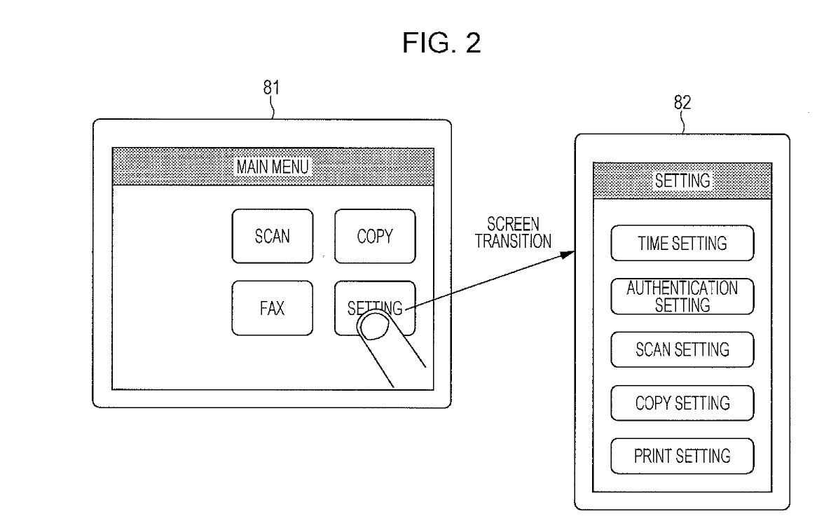

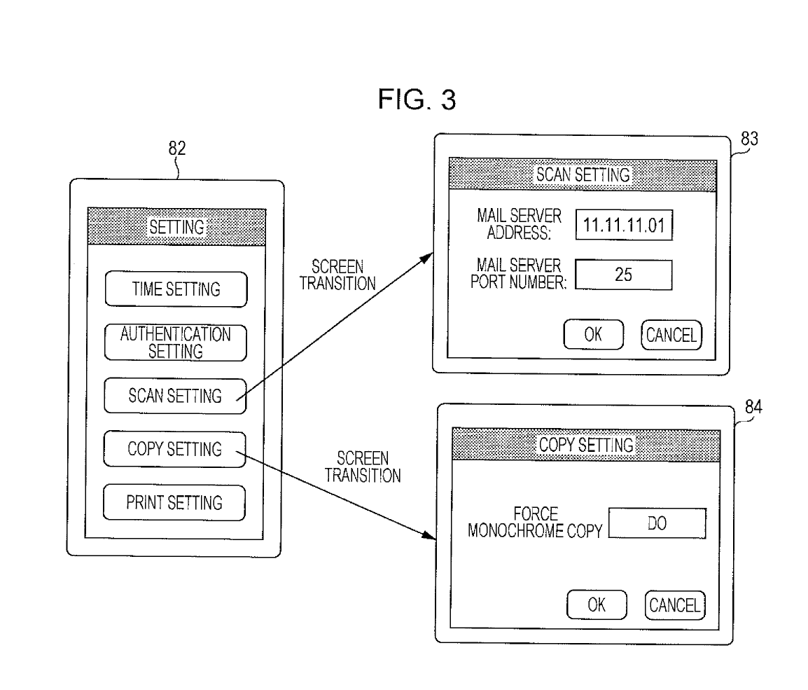

Next, with reference to FIGS. 2 and 3, a description will be given of an example of display screens in a case where an application program for adding a new function (additional program) is not installed and in a case where a setting function is implemented by operating an operation panel of the image forming apparatus 10.

As illustrated in FIG. 2, when a user operates a “setting” button on a menu screen 81 displayed on the operation panel of the image forming apparatus 10, the screen changes to a setting item selection screen 82.

The setting item selection screen 82 is a display screen for selecting a setting item for which a setting value is to be input, and includes selection buttons for selecting various setting items, such as “time setting”, “authentication setting”, and “scan setting”.

Here, the setting functions of time setting and authentication setting are necessary regardless of the functions of the apparatus, whereas the setting functions of scan setting, copy setting, and print setting are necessary because the apparatus has a scan function, a copy function, and a print function.

FIG. 3 illustrates an example of screen transition in a case where a button for selecting a setting item is operated on the setting item selection screen 82 illustrated in FIG. 2.

The example of screen transition illustrated in FIG. 3 shows a case where the “scan setting” button is operated and the “copy setting” button is operated on the setting item selection screen 82.

Specifically, FIG. 3 illustrates a state where a setting value input screen 83 for inputting a setting value of scan setting is displayed in response to an operation of the “scan setting” button, and a state where a setting value input screen 84 for inputting a setting value of copy setting is displayed in response to an operation of the “copy setting” button.

In FIGS. 2 and 3, “scan setting” and “copy setting” are used as the names of the setting items for which setting values necessary for the scan function and the copy function are to be input, for easy understanding of the correspondence. Actually, however, other names such as “network setting”, “use limitation setting”, and the like are used.

Various setting values input through the setting value input screens 83 and 84 are stored in a predetermined region, such as a hard disk drive (HDD), by the setting function. Accordingly, a scan application program (hereinafter simply referred to as a scan application) that implements the scan function and a copy application program (hereinafter simply referred to as a copy application) that implements the copy function are able to obtain information that is necessary for the implementation by reading the stored setting values.

Next, a description will be given of the image forming apparatus 10 according to the first exemplary embodiment. In particular, a description will be given of the case of adding an accumulated-document print function to the image forming apparatus 10.

The accumulated-document print function is a function of accumulating print jobs transmitted from the terminal apparatus 20 or the like to the image forming apparatus 10 without immediately executing the print jobs, and executing and printing only a print job selected by a user from among the accumulated print jobs.

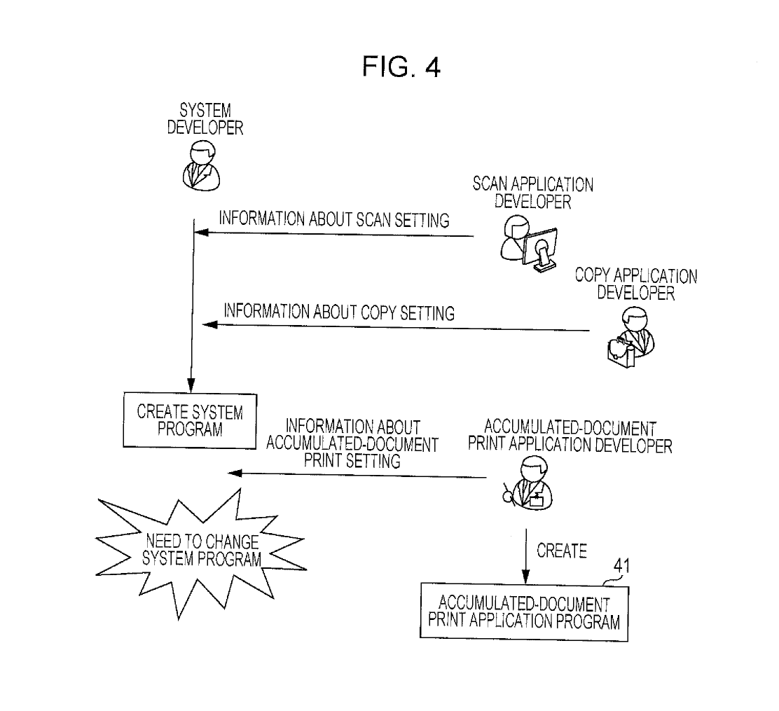

Now, with reference to FIG. 4, a description will be given of the case of adding, to common setting functions, a setting value input function for inputting a setting value of the added accumulated-document print function in a manner similar to that according to the related art.

For example, it is assumed that a scan application developer and a copy application developer who respectively develop a scan application and a copy application for implementing a scan function and a copy function are different from a system developer who develops a system program for controlling the entire apparatus.

In this case, the system developer may create a system program by acquiring information about scan setting and copy setting from the scan application developer and the copy application developer.

However, if an accumulated-document print application developer creates an accumulated-document print application program 41 for adding an accumulated-document print function after the system program has been created and it the system developer receives information about accumulated-document print setting and tries to add a function of inputting a setting value of the accumulated-document print setting to the setting function, the system developer needs to change the system program.

Accordingly, the system developer needs to change or modify the system program every time an application program for adding a new function is created.

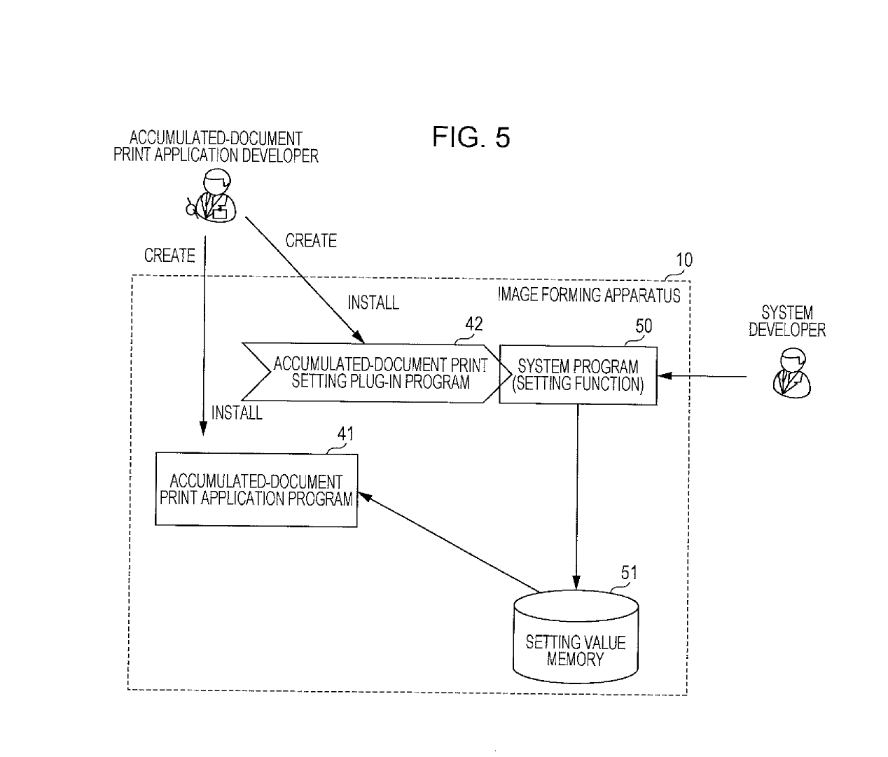

In the first exemplary embodiment, as illustrated in FIG. 5, the accumulated-document print application developer creates the accumulated-document print application program 41 and also creates an accumulated-document print setting plug-in program 42. The accumulated-document print application program 41 and the accumulated-document print setting plug-in program 42 that have been created are installed in the image forming apparatus 10.

In this way, the accumulated-document print application program 41, which is an additional program for implementing an additional function of accumulated-document printing that has newly been added, and the accumulated-document print setting plug-in program 42 are stored in, for example, a storage device 13 such as an HDD.

The accumulated-document print setting plug-in program 42 is a plug-in program that is configured to be able to dynamically link up with (cooperate with) a system program 50 that controls the entire apparatus and that contains information for inputting a setting value necessary to execute accumulated-document printing, which is an additional function.

Here, the plug-in program is a program having a plug-in function that is able to dynamically link up with another program, such as a program called “dynamic link library”.

In the first exemplary embodiment, the setting function of the system program 50 causes a plug-in program stored in a specific folder to be linked to the system program 50 and changes the setting function on the basis of information provided from the plug-in program.

If the plug-in program stored in the specific folder changes, for example, increases or decreases, the operation of the setting function also changes. However, it is not necessary to modify the code of the system program 50 that provides the setting function.

Thus, according to the first exemplary embodiment, even if no modification is added to the system program 50, the setting function changes in accordance with the added application program.

With the accumulated-document print setting plug-in program 42 being installed in the image forming apparatus 10 and stored in a predetermined folder, for example, the setting function of the system program 50 operates in cooperation with the accumulated-document print setting plug-in program 42. As a result, the setting item selection screen for selecting a setting item for which a setting value is to be input changes, and a selection button for accumulated-document print setting is displayed. If the selection button for accumulated-document print setting is operated, a setting value input screen for accumulated-document print setting is displayed.

The setting function of the system program 50 stores, in a setting value memory 51, a setting value input through the setting value input screen for accumulated-document print setting. Accordingly, the accumulated-document print application program 41 reads the setting value stored in a predetermined region of the setting value memory 51 and thereby obtains the setting value necessary to execute a process.

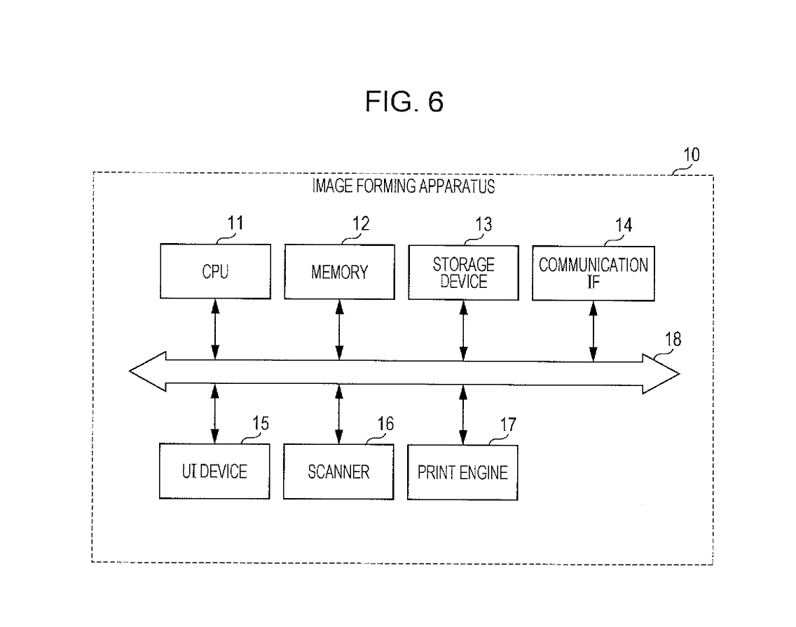

FIG. 6 illustrates the hardware configuration of the image forming apparatus 10 according to the first exemplary embodiment.

As illustrated in FIG. 6, the image forming apparatus 10 includes a central processing unit (CPU) 11, a memory 12, the storage device 13 such as an HDD, a communication interface (IF) 14 that transmits data to and receives data from an external apparatus or the like via the network 30, a user interface (UI) device 15 including a touch panel or liquid crystal display and a keyboard, a scanner 16, and a print engine 17. These elements are connected to one another via a control bus 18.

The print engine 17 prints an image on a recording medium, such as a print sheet, through the processes of charging, exposure, development, transfer, fixing, and so forth.

The CPU 11 executes a predetermined process on the basis of a system program stored in the memory 12 or the storage device 13 and controls the operation of the image forming apparatus 10. In the first exemplary embodiment, the CPU 11 reads and executes the system program stored in the memory 12 or the storage device 13. Alternatively, the program may be stored in a storage medium such as compact disc read only memory (CD-ROM) and may be provided to the CPU 11.

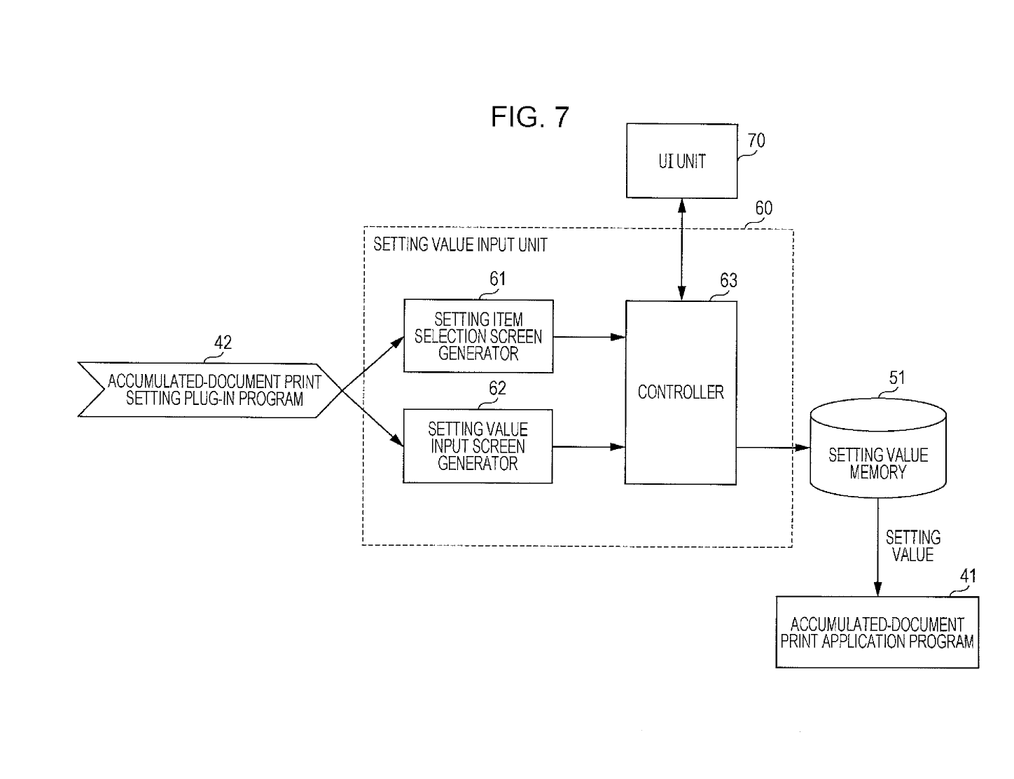

FIG. 7 is a block diagram illustrating the functional configuration related to the setting function of the image forming apparatus 10, which is implemented by executing the above-described system program. Here, a description will be given of only the configuration related to the setting function of the image forming apparatus 10.

As illustrated in FIG. 7, the image forming apparatus 10 according to the first exemplary embodiment includes a setting value input unit 60 that receives a setting value, a user interface (UI) unit 70 that receives an operation from a user via an operation panel or the like and performs display for the user, and the setting value memory 51 for storing an input setting value.

The setting value input unit 60 includes a setting item selection screen generator 61, a setting value input screen generator 62, and a controller 63. The setting item selection screen generator 61 generates a setting item selection screen for selecting a setting item for which a setting value is to be input. The setting value input screen generator 62 generates a setting value input screen for inputting a setting value of a setting item selected on the setting item selection screen. The controller 63 controls a setting value input operation.

The setting value input unit 60 forms the setting item selection screen and the setting value input screen by obtaining, from the accumulated-document print setting plug-in program 42, name information about a setting item of the setting value necessary to implement the additional function on the setting item selection screen and information about the setting value input for the setting item.

Specifically, the setting item selection screen generator 61 obtains, from the accumulated-document print setting plug-in program 42, name information about the setting item that needs to be displayed in accordance with addition of a function, and forms a setting item selection screen by using the obtained name information about the setting item for a setting item selection button.

On the other hand, the setting value input screen generator 62 obtains, from the accumulated-document print setting plug-in program 42, information about a setting value to be input for the setting item that needs to be input in accordance with addition of a function, and generates a setting value input screen.

Here, the information about the setting value to be input for the setting item includes the name of the setting value, information about an attribute of the setting value, and information about an identifier for identifying the setting value.

The controller 63 causes the UI unit 70 to display the setting item selection screen generated by the setting item selection screen generator 61. When a setting item is selected on the displayed screen, the controller 63 causes the UI unit 70 to display the setting value input screen corresponding to the selected setting item.

At this time, if the setting item of accumulated-document print setting for which input has become necessary due to addition of the function is selected, the controller 63 causes the UI unit 70 to display the setting value input screen generated based on the information obtained from the accumulated-document print setting plug-in program 42.

The setting value memory 51 stores the setting value input through the setting value input screen, together with information about an identifier for identifying the setting value.

The accumulated-document print application program 41 refers to the identifier stored in the setting value memory 51, and thereby specifies and obtains the setting value that is necessary to implement the additional function.

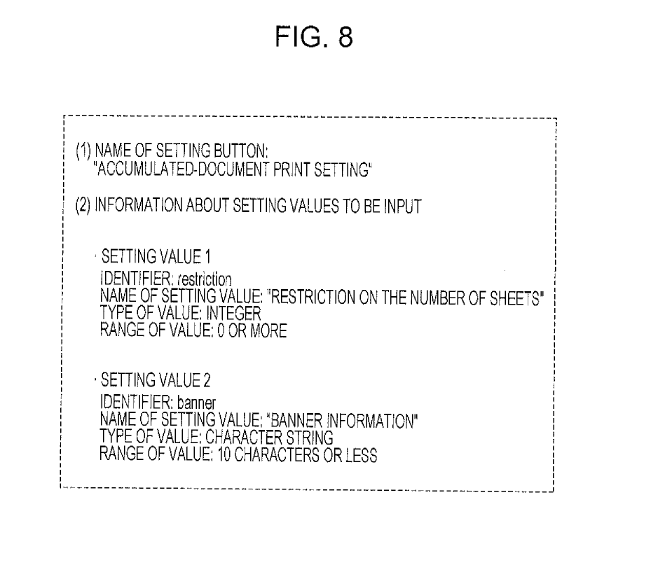

FIG. 8 illustrates an example of information about setting values of accumulated-document print setting, which is transmitted from the accumulated-document print setting plug-in program 42 to the system program 50.

In the information example illustrated in FIG. 8, the information “accumulated-document print setting” is set as the name of the setting item. FIG. 8 illustrates an example of two setting values. Regarding setting value 1, the character string “restriction” is set as information about an identifier for identifying the setting value, the information “restriction on the number of sheets” is set as the name of the setting value, the type of value “integer” is set as information about an attribute of the setting value, and the information “0 or more” is set as the range of the value.

Regarding setting value 2, the character string “banner” is set as information about an identifier for identifying the setting value, the information “banner information” is set as the name of the setting value, the type of value “character string” is set as information about an attribute of the setting value, and the information “10 characters or less” is set as the range of the value.

Setting value 1 is related to the restriction on the number of sheets when accumulated-document printing is executed. Setting value 2 is related to the setting of the content to be printed as banner information, for example, at the upper right corner of each sheet when accumulated-document printing is executed.

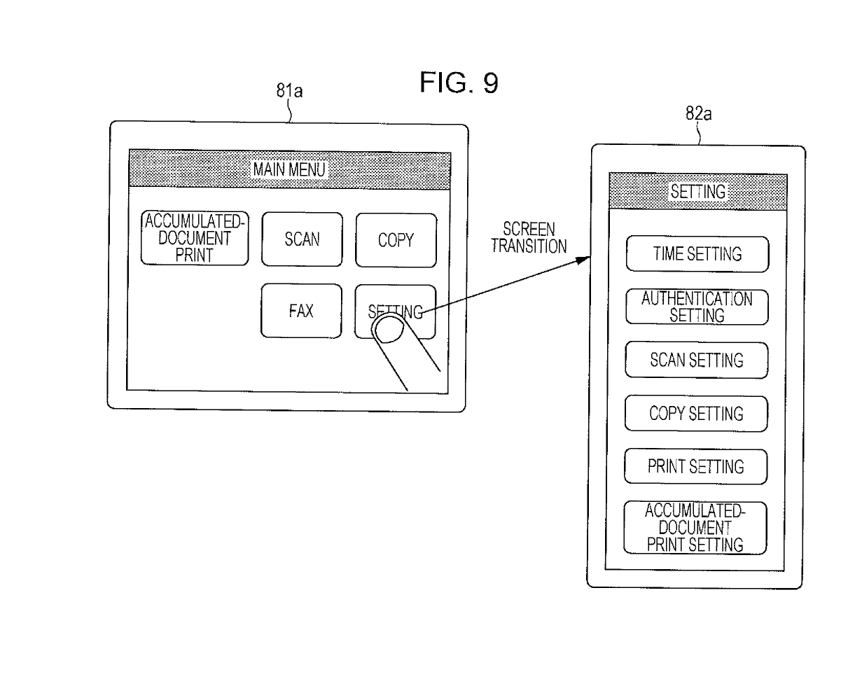

FIGS. 9 to 11 illustrate examples of transition of setting screens that are displayed when the information illustrated in FIG. 8 is obtained from the accumulated-document print setting plug-in program 42.

First, FIG. 9 illustrates a menu screen 81a and a setting item selection screen 82a that are displayed on the operation panel. On the menu screen 81a, it is understood that the function selection button “accumulated-document print” is added in accordance with the addition of the accumulated-document print function.

When the user operates the “setting” button on the menu screen 81a illustrated in FIG. 9, the display changes and the setting item selection screen 82a is displayed.

On the setting item selection screen 82a, the setting item selection button with the name “accumulated-document print setting” is added in accordance with the installation of the accumulated-document print setting plug-in program 42.

When the user operates the selection button “accumulated-document print setting” on the setting item selection screen 82a, the screen changes from the setting item selection screen 82a to a setting value input screen 83a, as illustrated in FIG. 10.

The setting value input screen 83a is generated on the basis of the information illustrated in FIG. 8, and includes blank fields for setting values to be input, together with the names “restriction on the number of sheets” and “banner information”.

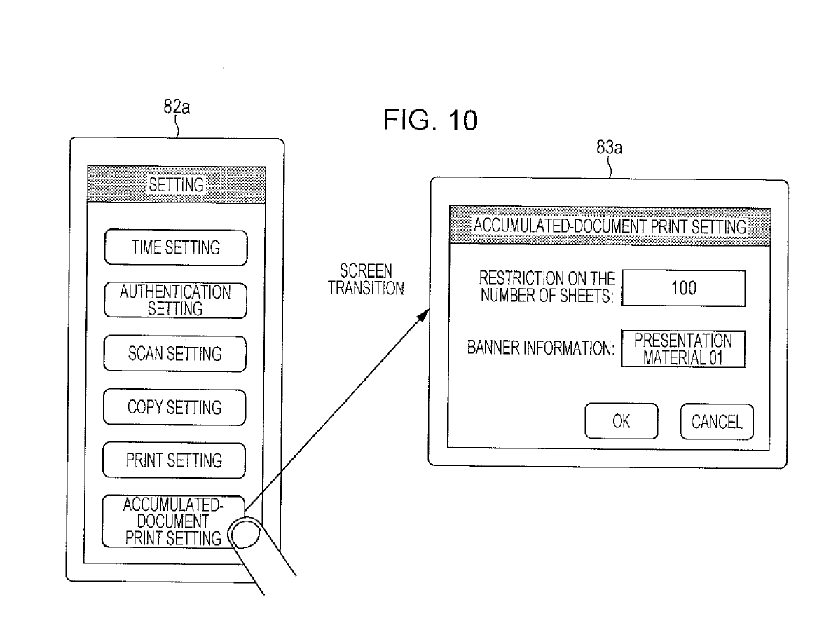

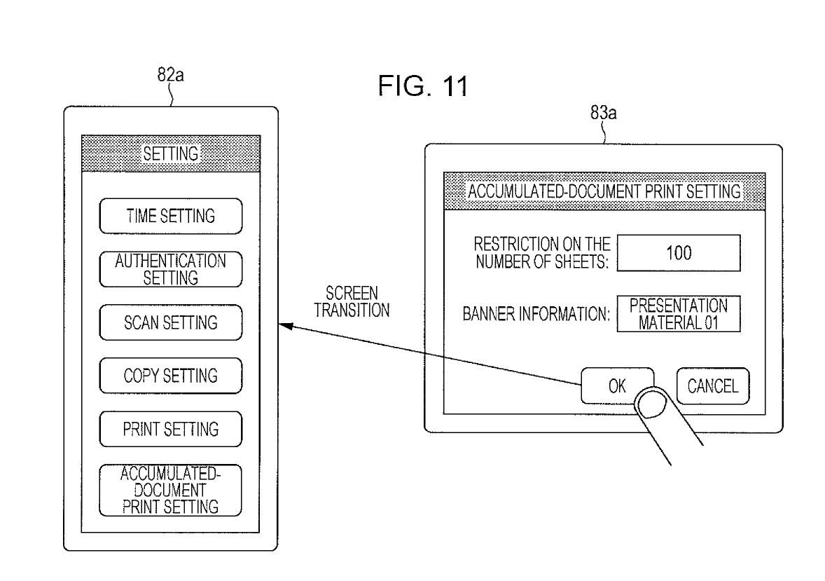

As illustrated in FIG. 11, when the user inputs setting values through the setting value input screen 83a and operates an “OK” button, input of the setting values is completed and the screen returns to the setting item selection screen 82a.

FIG. 11 illustrates an example in which the information “100” is set as the restriction on the number of sheets and the information “presentation material 01” is set as banner information.

In response to the input of these setting values, the controller 63 of the setting value input unit 60 stores the input setting values in the setting value memory 51 together with information about their identifiers.

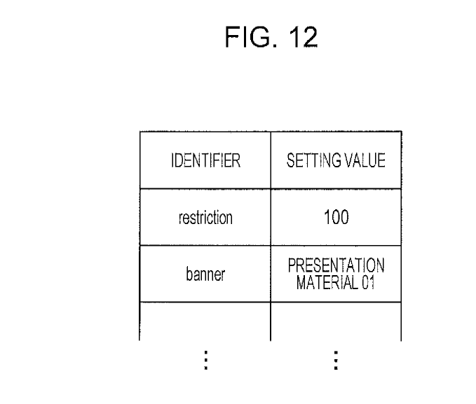

Here, the identifier “restriction” is set for the setting value of the restriction on the number of sheets, and the identifier “banner” is set for the setting value of the banner information. Thus, the setting value “100” is stored in association with the identifier “restriction” and the setting value “presentation material 01” is stored in association with the identifier “banner” in the setting value memory 51, as illustrated in FIG. 12.

The accumulated-document print application program 41 specifies the setting values to be obtained by referring to the identifiers “restriction” and “banner”, and obtains the setting value “100” of the restriction on the number of sheets and the setting value “presentation material 01” of the banner information. The accumulated-document print application program 41 then executes an accumulated-document printing process by using the obtained setting values.

### Second Exemplary Embodiment

Next, an image forming apparatus according to a second exemplary embodiment of the present invention will be described.

The image forming apparatus according to the second exemplary embodiment has a basic configuration similar to that of the above-described image forming apparatus 10 according to the first exemplary embodiment, and thus only the difference therebetween will be described. In the second exemplary embodiment, the same elements as those of the first exemplary embodiment are denoted by the same reference numerals, and the description thereof is omitted.

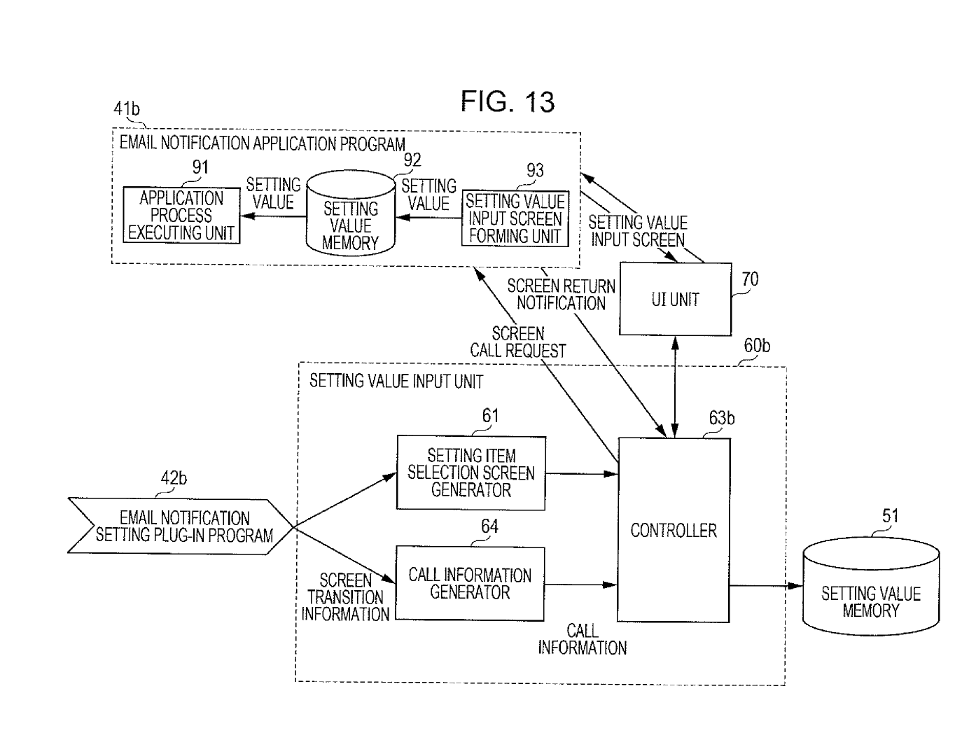

In the following description of the image forming apparatus according to the second exemplary embodiment, a description will be given of the case of adding, to the image forming apparatus, an email notification function for automatically transmitting an email to a designated destination if the timing or state that is registered in advance occurs. The functional configuration of the image forming apparatus according to the second exemplary embodiment is illustrated in FIG. 13.

As illustrated in FIG. 13, a setting value input unit 60b according to the second exemplary embodiment is different from the setting value input unit 60 according to the first exemplary embodiment illustrated in FIG. 7 in that a call information generator 64 is provided instead of the setting value input screen generator 62 and a controller 63b is provided instead of the controller 63.

In the second exemplary embodiment, an email notification application program 41b for implementing an email notification function and an email notification setting plug-in program 42b containing information for email notification setting are generated and installed in the image forming apparatus.

Also in the second exemplary embodiment, the setting item selection screen generator 61 obtains, from the email notification setting plug-in program 42b, name information about the setting item of email notification setting for inputting a setting value of the email notification function as an additional function, and forms a setting item selection screen by using the obtained name information about the setting item for a setting item selection button.

If the setting item of email notification setting is selected on the setting item selection screen that is displayed, the call information generator 64 obtains screen transition information for shifting to the setting value input screen for inputting a setting value from the email notification setting plug-in program 42b and converts the screen transition information to generate call information. The details of the screen transition information and the call information will be described below. Subsequently, the controller 63b transmits the call information generated by the call information generator 64 to the email notification application program 41b, and thereby makes a call request to the email notification application program 41b to display the setting value input screen.

In this way, the setting value input unit 60b according to the second exemplary embodiment forms a setting item selection screen by obtaining, from the email notification setting plug-in program 42b, name information about the setting item of the setting value necessary to implement the additional function on the setting item selection screen. Also, the setting value input unit 60b obtains screen transition information from the email notification setting plug-in program 42b, generates call information by using the screen transition information if the setting item of the setting value necessary to implement the additional function is selected on the setting item selection screen, transmits the call information, and thereby makes a call request to the email notification application program 41b to display the setting value input screen.

The call request transmitted from the setting value input unit 60b to the email notification application program 41b may include screen configuration information, such as the font and color to be used in the setting value input screen.

In response to the call request including the font size and font type of characters used in the setting item selection screen and color information for displaying the screen, the email notification application program 41b displays the setting value input screen in accordance with the characters and colors of the setting item selection screen.

The email notification application program 41b according to the second exemplary embodiment includes an application process executing unit 91, a setting value memory 92, and a setting value input screen forming unit 93.

The setting value input screen forming unit 93 displays a setting value input screen on the UI unit 70 in response to a screen call request received from the setting value input unit 60b. After a setting value has been input through the displayed setting value input screen, the setting value input screen forming unit 93 provides a screen return notification to the setting value input unit 60b.

The setting value memory 92 stores the setting value input through the setting value input screen. The application process executing unit 91 obtains the setting value stored in the setting value memory 92 and executes the process of the email notification function.

Next, the difference between the configuration according to the second exemplary embodiment and the configuration according to the above-described first exemplary embodiment will be described with reference to FIG. 14.

In the first exemplary embodiment, both the setting item selection screen and the setting value input screen are created and displayed by the setting function implemented by the system program. On the other hand, in the second exemplary embodiment, the setting item selection screen is created and displayed by the setting function implemented by the system program as in the first exemplary embodiment, whereas the setting value input screen, which is displayed when the setting item of the additional function on the setting item selection screen is selected, is created and displayed by the email notification application program 41b.

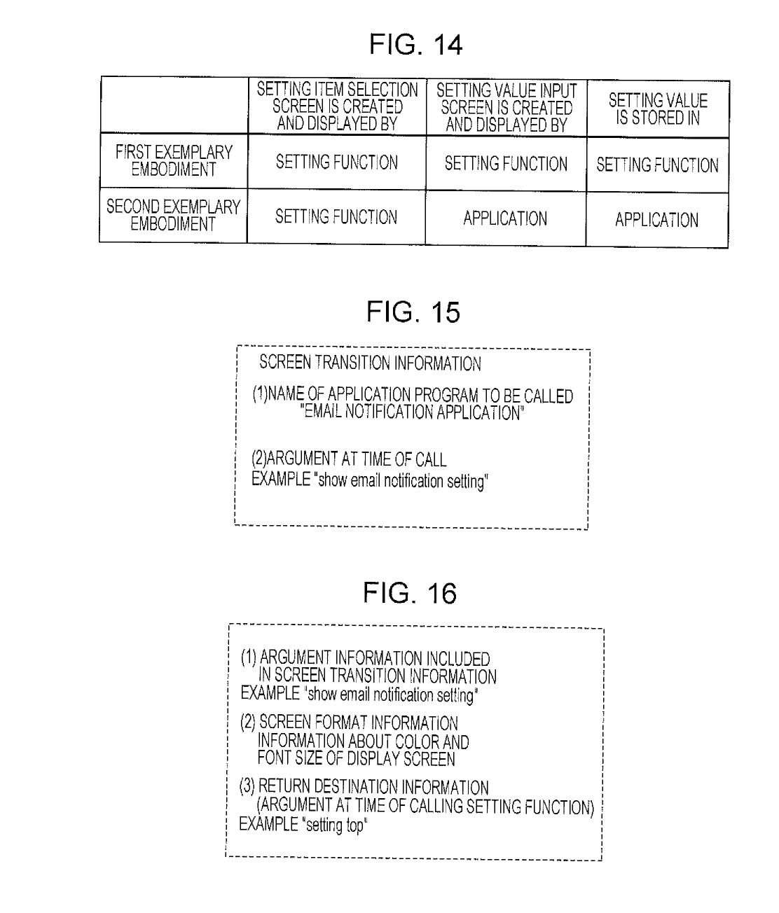

FIG. 15 illustrates an example of screen transition information transmitted from the email notification setting plug-in program 42b to the system program, and FIG. 16 illustrates an example of call information generated by the call information generator 64.

The screen transition information illustrated in FIG. 15 is made up of the information “email notification application”, which is the name of the application program to be called, and the information about the argument at the time of call “show email notification setting”, which is information for providing an instruction to display a setting value input screen of email notification setting.

The call information illustrated in FIG. 16 is made up of, in addition to the information about the argument at the time of all “show email notification setting” included in the screen transition information, screen format information about the color and font size of the screen to be displayed and return destination information “setting top” at the time of calling the setting function.

If the above-described call information is transmitted from the controller 63b of the setting value input unit 60b to the email notification application program 41b, the setting value input screen forming unit 93 of the email notification application program 41b receives the argument information “show email notification setting”, forms a setting value input screen for email notification setting, and displays the setting value input screen on the UT unit 70.

After a setting value has been input through the setting value input screen for email notification setting, return destination information “setting top” is transmitted from the email notification application program 41b to the controller 63b, and thereby a notification indicating the return to the setting item selection screen is provided.

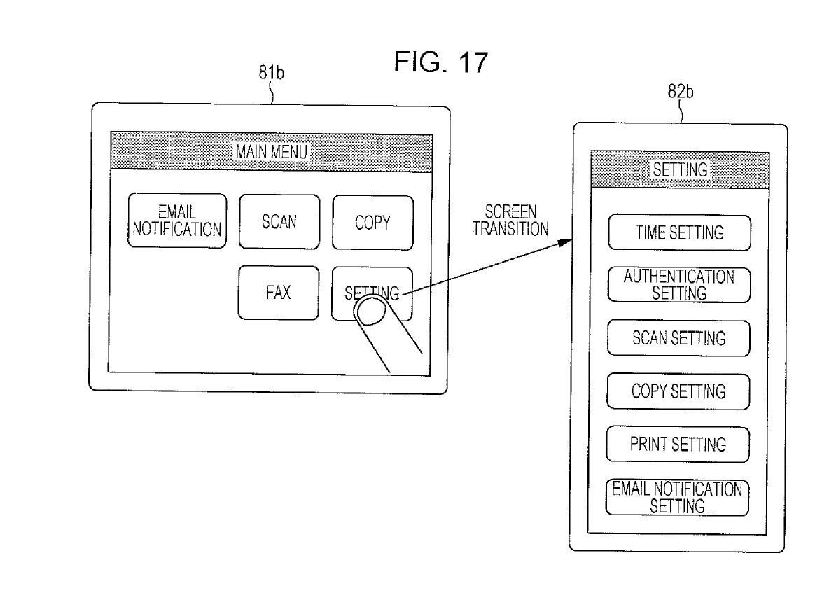

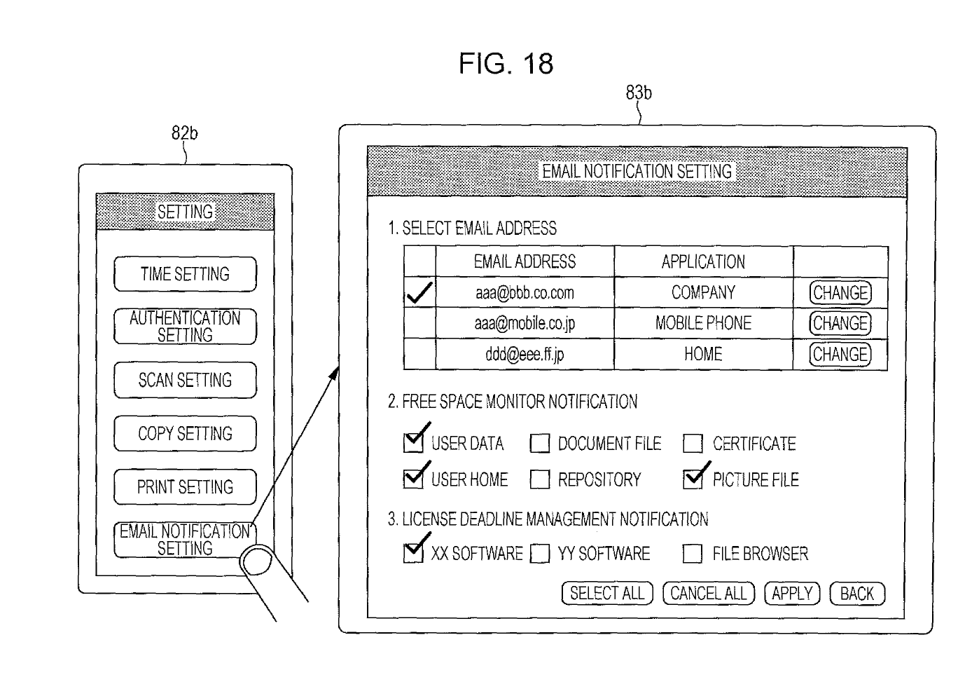

FIGS. 17 and 18 illustrate an example of transition of a setting screen that is displayed in a case where the information illustrated in FIGS. 15 and 16 is used.

FIG. 17 illustrates a menu screen 81b and a setting item selection screen 82b that are displayed on the operation panel. On the menu screen 81b, it is understood that the function selection button “email notification” is added in accordance with the addition of email notification function.

When the user operates the “setting” button on the menu screen 81b illustrated in FIG. 17, the display changes and the setting item selection screen 82b is displayed.

On the setting item selection screen 82b, a setting item selection button with the name “email notification setting” is added in accordance with the installation of the email notification setting plug-in program 42b.

When the user operates the selection button “email notification setting” on the setting item selection screen 82b, the screen changes from the setting item selection screen 82b to a setting value input screen 83b, as illustrated in FIG. 18.

The setting value input screen 83b for email notification setting illustrated in FIG. 18 is not generated by the setting value input unit 60b but is generated by the email notification application program 41b. Thus, the setting value input screen 83b has a complicated configuration compared to the case where the setting value input screen is generated by the setting value input unit 60b.

Specifically, the setting value input screen 83b for email notification setting illustrated in FIG. 18 is able to display a table showing plural email addresses and applications obtained from address book data, display check boxes to prompt the user to make a selection, and display the buttons “select all”, “cancel all”, and so forth.

In contrast, the setting value input screen 83a according to the first exemplary embodiment illustrated in FIG. 10 has a simple configuration in which the user only has to input a setting value to a predetermined field.

### Modification Example

The above-described exemplary embodiments of the present invention are applied to an image forming apparatus. Alternatively, the exemplary embodiments may be applied to an information processing apparatus other than the image forming apparatus, if the setting function is independent of other various functions in the information processing apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a setting value input unit that displays a setting item selection screen for selecting a setting item for which a setting value is to be input, that displays, in response to selection of a setting item on the setting item selection screen, a setting value input screen for inputting a setting value of the setting item, and that receives a setting value;
a first memory that stores an additional program for implementing a newly added additional function; and
a second memory that stores a plug-in program which is configured to be able to dynamically cooperate with a system program that controls the entire information processing apparatus and which contains information for inputting a setting value necessary to implement the additional function,
wherein the setting value input unit forms the setting item selection screen and the setting value input screen by obtaining, from the plug-in program, name information about a setting item of the setting value necessary to implement the additional function on the setting item selection screen and information about the setting value to be input for the setting item.

2. The information processing apparatus according to claim 1, wherein
the setting value input unit displays, as a setting item selection button, the name information about the setting item obtained from the plug-in program, and
the information about the setting value to be input for the setting item includes a name of the setting value, information about an attribute of the setting value, and information about an identifier for identifying the setting value.

3. The information processing apparatus according to claim 2, further comprising:
a third memory that stores a setting value that has been input, together with information about an identifier for identifying the setting value,
wherein the additional program refers to the identifier stored in the third memory to specify and obtain a setting value necessary to implement the additional function.

4. A non-transitory computer readable medium storing a program causing a computer to execute a process, the process comprising:
in a case of displaying a setting item selection screen for selecting a setting item for which a setting value is to be input, if an additional program for implementing a newly added additional function is installed, forming the setting item selection screen by obtaining, from a plug-in program which is configured to be able to dynamically cooperate with a system program that controls an entire information processing apparatus and which contains information for inputting a setting value necessary to implement the additional function, name information about a setting item of the setting value necessary to implement the additional function on the setting item selection screen;
if the setting item of the setting value necessary to implement the additional function is selected on the setting item selection screen, forming and displaying a setting value input screen for inputting a setting value of the setting item by using information about the setting value to be input for the setting item obtained from the plug-in program; and
storing a setting value input through the setting value input screen.

5. A non-transitory computer readable medium storing a program causing a computer to execute a process, the process comprising:
in a case of displaying a setting item selection screen for selecting a setting item for which a setting value is to be input, if an additional program for implementing a newly added additional function is installed, forming the setting item selection screen by obtaining, from a plug-in program which is configured to be able to dynamically cooperate with a system program that controls an entire information processing apparatus and which contains information for inputting a setting value necessary to implement the additional function, name information about a setting item of the setting value necessary to implement the additional function on the setting item selection screen; and
if the setting item of the setting value necessary to implement the additional function is selected on the setting item selection screen, making a call request to the additional program to display a setting value input screen by using transition information for shifting to the setting value input screen for inputting the setting value obtained from the plug-in program.
